(19) United States
(12) Patent Application Publication
(10) Pub. No.: US 2010/0136929 A1
(43) Pub. Date: Jun. 3, 2010

(54) METHOD AND MULTI-CHANNEL RF TRANSMITTER ARRANGEMENT FOR GENERATING RF FIELDS

(75) Inventors: Peter Vernickel, Hamburg (DE); Ulrich Katscher, Norderstedt (DE)

Correspondence Address: PHILIPS INTELLECTUAL PROPERTY & STANDARDS, P. O. Box 3001, BRIARCLIFF MANOR, NY, 10510, US

(73) Assignee: KONINKLIJKE PHILIPS ELECTRONICS N.V., EINDHOVEN (NL)

(21) Appl. No.: 12/598,448

(22) PCT Filed: Apr. 25, 2008
(86) PCT No.: PCT/IB08/51607

§ 371 Date: Nov. 2, 2009

(30) Foreign Application Priority Data
May 4, 2007 (EP) 07107490.0
May 15, 2007 (EP) 07108193.9

(51) Int. Cl. H04B 1/02

(52) U.S. Cl. 455/91

(57) ABSTRACT

A multi-channel RF transmitter arrangement in the form of, or comprising, a plurality RF antennas, antenna elements, coils or coil elements (11 to 16), for generating an RF field, especially for use in a magnetic resonance imaging (MRI) system for exciting nuclear magnetic resonances (NMR), and a method for generating such an RF field is disclosed. Furthermore, a multi-channel RF transmit system comprising a plurality of RF waveform generators (31, 32, . . . 3n) and RF amplifiers (21, 22, . . . 2n) for generating RF transmit signals for feeding such a multi-channel RF transmitter arrangement, especially for use as an RF excitation system in an MRI system is disclosed.

### FIELD OF INVENTION

The invention relates to a multi-channel RF transmitter arrangement in the form of, or comprising, a plurality of RF transmitters like RF antennas, antenna elements, coils or coil elements or other resonator elements, for generating an RF field, especially a plurality of RF field components, so that the RF field is a composite RF field, especially for use in a magnetic resonance imaging (MRI) system for exciting nuclear magnetic resonances (NMR), and a method for generating such an RF field.

Furthermore, the invention relates to a multi-channel RF transmit system comprising a plurality of RF waveform generators and RF amplifiers, for generating RF transmit signals for feeding such a multi-channel RF transmitter arrangement, especially for use as an RF excitation system in an MRI system.

The invention as well relates to an MRI system comprising such a multi-channel RF transmit or excitation system and such a multi-channel RF transmitter arrangement.

### BACKGROUND OF THE INVENTION

WO 2004/061469 discloses a high-frequency system for an MR apparatus with multiple transmit channels and an RF coil arrangement comprising a plurality of resonator elements, wherein each one transmit channel is assigned to each resonator element. Each transmit channel can be controlled individually, so that an RF field can be generated in an examination volume with a field distribution that can be pre-selected flexibly and variably.

### SUMMARY OF THE INVENTION

It has revealed that a disadvantage of the above RF transmitter or coil arrangement comprising a plurality of resonator elements is, that in case that an excitation of the whole field of view, i.e. of at least substantially the whole examination volume, is required, the phases and amplitudes of all the different transmit channels feeding each one of the resonator elements have to be calibrated accurately and separately in order to generate a homogeneous RF excitation field.

Another disadvantage is that a single-channel body coil with a homogeneous field (homogeneous field in case of an unloaded coil, since the load distorts the field) which is often needed as a reference in many scans, is not provided in the RF transmitter or coil arrangement as disclosed in the above WO 2004/061469.

One object underlying the invention is to provide a multi-channel RF transmitter arrangement in the form of, or comprising, a plurality of RF antennas, antenna elements, coils or coil elements (resonators), and a related method, by which an excitation of the whole field of view, i.e. of a global or extensive RF field, can be performed much simpler and with much less complicated calibration procedures.

Another object underlying the invention is to provide a multi-channel RF transmit system for feeding the above RF transmitter arrangement, which RF transmit system can be realized at considerably reduced costs in comparison to the above known multi-channel RF transmit system.

The object is solved by a multi-channel RF transmitter arrangement according to claim 1, a multi-channel RF transmit system according to claim 7 and a method for generating an RF field according to claim 9.

This solutions according to the invention are especially advantageous in those MRI systems with higher magnetic field strength, in which the wavelengths of the required RF transmit or excitation signals reach the dimensions of an examination object, so that wave propagation or dielectric resonance effects within the examination object and inhomogeneous RF excitation fields can occur. The impact of these unwanted effects and especially of signal intensity variations during MRI examinations can be compensated effectively and in an easy and cost-effective manner by transmitting spatially selective RF pulses by means of a multi-channel RF transmit system and a multi-channel RF transmitter arrangement according to the invention.

Moreover, a parallel transmission of RF pulses and methods like Transmit SENSE (see Katscher et al, “Transmit SENSE” in Magnetic Resonances in Medicine (2003) 49: 144-150) and RF shimming (see Ibrahim et al, “Effect of RF coil excitation on field inhomogeneity at ultra high fields: a field optimized TEM resonator” in Magnetic Resonance Imaging (2001) December; 19(10): 1339-47) can be applied in order to facilitate the excitation of arbitrarily shaped or spatially intricate RF field patterns, and the required time to produce such an RF excitation field can be reduced.

The subclaims disclose advantageous embodiments of invention.

The first RF transmitters according to claims 2 and 3 and the second RF transmitters according to claims 4 to 6 are especially advantageous in case of use of the related multi-channel RF transmitter arrangements in an MRI system for exciting nuclear magnetic resonances.

It will be appreciated that features of the invention are susceptible to being combined in any combination without departing from the scope of the invention as defined by the accompanying claims.

Further details, features and advantages of the invention will become apparent from the following description of preferred and exemplary embodiments of the invention, which are given with reference to the drawings.

### BRIEF DESCRIPTION OF THE DRAWINGS

FIG. 1 shows a schematic block diagram of a multi-channel RF transmitter arrangement and a multi-channel RF transmit system according to a preferred embodiment of the invention.

FIG. 2 shows correlation between desired and obtained magnitude for excitation patterns with and without phase demand.

### DETAILED DESCRIPTION OF EMBODIMENTS

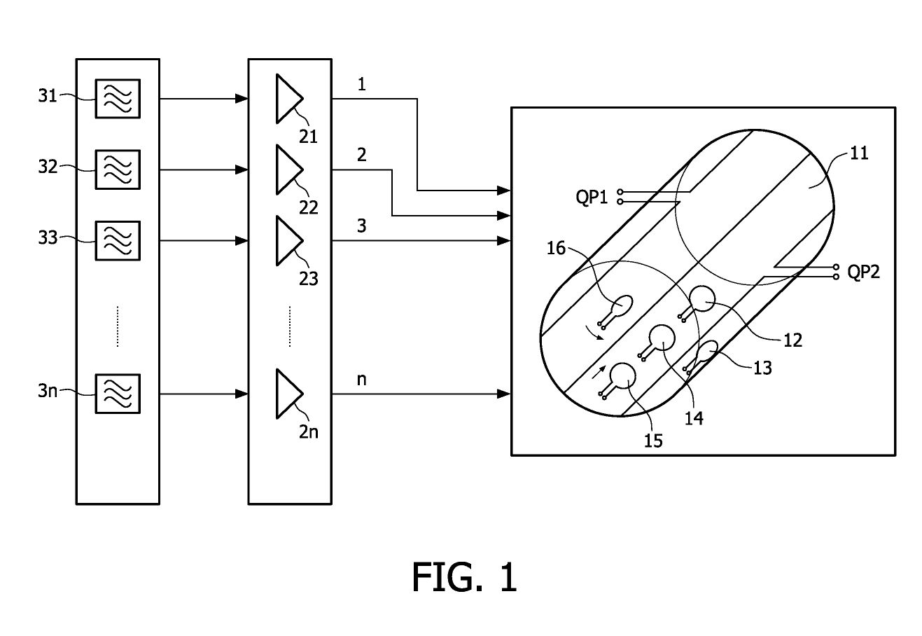

Generally, a multi-channel RF transmitter arrangement according to the invention comprises at least one first RF transmitter for generating an RF excitation field within at least substantially the whole examination volume of an MRI system (i.e. a “global” or extensive RF field) for exciting nuclear magnetic resonances in an examination object. Such a first RF transmitter is known in the form of a cylindrical coil and especially a body coil (BC) which cylindrically surrounds or encloses the global or extensive RF field, i.e. the examination volume. In case of a horizontal MRI system (which is exemplarily shown in FIG. 1) such a body coil is usually a so-called birdcage coil. Other body coils are based on TEM resonators. In case of a vertical MRI system or an open MRI system, the body coil is usually provided in the form of two planar antenna structures which are positioned at least substantially parallel to each other and at the axial ends of a preferably cylindrical examination volume, so that the global or extensive RF field extends between the two planar antenna structures.

Furthermore, a multi-channel RF transmitter arrangement according to the invention comprises at least one but preferably a plurality of second RF transmitters which are positioned within the global or extensive RF field for generating each a local RF excitation field within the examination volume (i.e. within the global or extensive RF field). A local RF excitation field is to be understood as an RF excitation field within a space or zone of the examination volume which is enclosed by the related second RF transmitter, as well as a space or zone outside of the related second RF transmitter in which the RF excitation field of the related second RF transmitter is essentially concentrated and effective for locally exciting nuclear magnetic resonances in an examination object.

The second RF transmitters can be provided in the form of RF antenna elements, coils, coil elements, loops, TEM element coils, and/or segmented antenna elements, or other resonator elements, which are positioned preferably either within the plane or surface of the first RF transmitter, especially the body coil, or closer to an examination object, i.e. more in the inner of the examination volume.

Furthermore, RF transmit surface coils, for example in the form of movable coils or pads or head coils which are placed near the expected field of view or an area to be imaged can be used as well as second RF transmitters.

A multi-channel RF transmit system according to the invention generally comprises a number of RF transmit channels, which number corresponds with the total number of first and second RF transmitters. Each RF transmit channel usually comprises at least a waveform generator and a power amplifier for feeding the connected RF transmitter with an RF signal for exciting nuclear magnetic resonances within an examination object.

Due to the fact, that in contrary to the above mentioned prior art only the at least one first RF transmitter has to generate an RF field which excites magnetic resonances at least substantially within the whole examination volume (i.e. a global or extensive RF field), and the second RF transmitters are provided for generating only a local RF excitation field, only those RF transmit channels which are connected with one of the first RF transmitters have to be high power RF transmit channels (of e.g. about 10 kW), whereas the other RF transmit channels which are connected with one of the second RF transmitters can be designed for generating accordingly reduced or lower or midrange power (of e.g. about 1 kW). As the price of an RF amplifier increases nonlinearly with increasing power, a considerable cost reduction of the whole RF transmit system and accordingly of the entire MRI system can be achieved.

By means of the above multi-channel RF transmitter arrangement in combination with the above multi-channel RF transmit system, a spatially distributed and even intricate RF excitation field pattern (or composite RF field) can be generated by transmitting several RF field components in parallel by the respective RF transmitters.

In parallel transmission the RF excitation field is built of from several (local) RF field components that are emitted by respective antennae (coil) elements. The compound excitation field is formed as a superposition, notably a linear combination of these local RF field components on the basis of the spatial emission profiles of the antennae.

According a further aspect of the invention, the local RF field components are set such that the magnitude of the RF excitation field built up from the RF field components accurately satisfies the desired excitation pattern. In the iterative solution of the RF field components from the desired magnitude pattern additional phase are added, or the iteration is driven on the magnitude of the field being built-up.

An additional degree of freedom is achieved in solving the inverse problem and improves the accuracy of the magnitude pattern and/or stabilising the inversion problem.

The standard equation for parallel transmission is

$${P}_{des} ( \vec{x} ) = {\sum }_{n \leq N} {S}_{n} ( \vec{x} ) {P}_{n} ( \vec{x} ) \qquad ( 1 )$$

with P_{des} the desired complex excitation pattern, Sₙ the complex sensitivity distribution of coil n, and Pₙ the complex excitation pattern of coil n. Equation (1) can be solved, e.g., by a (regularized) pseudo-inversion (denoted by +) in the discretised excitation k-space (denoted by bold, non-italic letters)

p_{full}=s_{full}⁺p_{des}. (2)

Here, p_{full} contains the spatially selective RF pulses for the N different coils, s_{full} is the sensitivity matrix, and p_{des} the desired excitation pattern in k-space. For this invention, only the magnitude of the left hand side of Eq. (1) is of interest

$$\vert {P}_{des} ( \vec{x} ) \vert = {\sum }_{n \leq N} {S}_{n} ( \vec{x} ) {P}_{n} ( \vec{x} ) . \qquad ( 3 )$$

Equation (3), however, cannot be solved via linear algebra as before, and an iterative solution has to be applied. Two different examples of such iterative solutions are described in the following.

A couple of different arbitrary test phase distributions are added to P_{des}. The test phase distributions may be calculated randomly, or systematically using sets of of different polynomials. For each test phase, the corresponding Pₙ are calculated via Eq. (2) as before. Each test phase is benchmarked by simulating an experiment via Eq. (1) for the corresponding calculated Pₙ. For instance, the correlation between the calculated and the desired magnitude of P_{des} can be taken for this benchmark. In the real experiment, the Pₙ yielding the best benchmark is used.

For the standard complex case, Eq. (1) can be solved iteratively, e.g., via a (non-linear) conjugate gradient method. Here, in each iteration step, the calculated P_{des} and the desired P_{des} is compared, before a new set of Pₙ is calculated. This comparison is usually performed in a complex way. For this invention, only the magnitude of P_{des} is compared. This method offers a more systematic approach for optimizing the phase of P_{des} than the method sketched in (i).

In both versions of these iterations, it is preferred to limited the occurring spatial phase variations small enough to avoid significant intra-voxel dephasing. This is easily achieved in that a predetermined limitation of the phase variations is imposed as a constraint in the iterations.

The aspect of the invention in which the local RF fields are superposed to form the predetermined spatial magnitude pattern can be applied for shortening 2D as well as 3D RF pulses.

This aspect of the invention can also be applied not to improve the excitation result, but to reduce the mean B₁ amplitude of the RF pulses, i.e., the occurring SAR.

This aspect of invention can be used for all applications, where parallel transmission is used for spatially selective RF pulses. The most prominent application example is the compensation of B1 inhomogeneities.

In FIG. 1, a preferred embodiment of a multi-channel RF transmitter arrangement and a multi-channel RF transmit system is shown and

The RF transmitter arrangement comprises two first RF transmitters which are formed by a known body coil 11, and a plurality of second RF transmitters in the form of small RF coils or loops 12 to 16 which are distributed or segmented along the longitudinal direction of the body coil 11 and/or in a circumferential direction of the body coil 11.

The body coil 11 which usually can be used in the conventional quadrature mode, is for multi-channel transmit applications preferably used with its two modes separately. It accordingly comprises a first quadrature port QP1 and a second quadrature port QP2 for generating two independently fed and excited quadrature modes, so that two first RF transmitters are provided.

According to a variation of this body coil (birdcage coil) 11, the body coil 11 itself can be segmented in its longitudinal or z-direction in order to add more degrees of freedom with respect to the generation of the RF excitation field pattern within the whole examination volume.

According to FIG. 1, five second RF transmitters 12 to 16 are exemplarily shown, wherein each three of the second RF transmitters 12, 14, 15 are distributed or segmented in the longitudinal or axial direction (z-direction) of the birdcage coil 11, and three of the second transmitters 13, 14, 16 are distributed or segmented in a circumferential direction of the birdcage coil 11.

The multi-channel RF transmit system according to FIG. 1 comprises a number n of RF transmit channels according to the number n of first and second RF transmitters, wherein each RF transmit channel comprises at least an RF power amplifier 21, 22, 23, . . . 2n and a waveform generator 31, 32, 33, . . . 3n.

The first RF transmit channel 21, 31 is connected with the first quadrature port QP1 of the birdcage coil 11 and the second RF transmit channel 22, 32 is connected with the second quadrature port QP2 of the birdcage coil 11, wherein the other RF transmit channels 23, 33; . . . 2n, 3n are connected with each one of the second RF transmitters 12 to 16.

Consequently, the first and the second RF transmit channels 21, 31; 22, 32 have to be high power channels, whereas the other RF transmit channels 23, 33; . . . 2n, 3n are lower (or midrange) power channels as explained above.

The use of the birdcage coil 11 (quadrature coil) with its two independent modes (quadrature modes) has the advantage, that these modes are inherently decoupled. A decoupling of the second RF transmitters 12 to 16 from each other and from the first RF transmitters (birdcage coil) 11 can be obtained by several known methods for operating the RF transmitters independently (and for decoupling the RF transmitters) and for achieving the required independent sensitivities of all RF transmitters. A decoupling of the first and the second RF transmitters and of the second RF transmitters from each other can be achieved e.g. by one of the methods or a combination of the methods as disclosed in the following references:

Vernickel P, Findeklee C, Eichmann E, Grässlin I.: Active digital decoupling for multi-channel transmit MRI Systems. In: Proceedings of the 15th Annual Meeting of ISMRM, Berlin, Germany, 2007, p 170.

Leussler Ch, Stimma J, Röschmann P.: The Bandpass Birdcage Resonator Modified as a Coil Array for Simultaneous MR Acquisition. In: Proceedings of the 5th Annual Meeting of ISMRM, Vancouver, Canada, 1997, p 176.

Lee R F, Giaquinto R O, and Hardy C J.: Coupling and Decoupling Theory and Its Application to the MRI Phased Array. In: Magn Reson Med 2002; 48:203-213.

Kurpad K N, Boskamp E B, Wright S M.: A Parallel Transmit Volume Coil With Independent Control of Currents on the Array Elements. In: Proceedings of the 13th Annual Meeting of ISMRM, Miami, USA, 2005, p 13.

Junge S, Seifert F, Wuebbeler G, Rinneberg H.: Current Sheet Antenna Array—a transmit/receive surface coil array for MRI at high fields. In: Proceedings of the 12th Annual Meeting of ISMRM, Kyoto, Japan, 2004, p 41.

Jevtic J.: Ladder Networks for Capacitive Decoupling in Phased-Array Coils. In: Proceedings of the 9th Annual Meeting of ISMRM, Glasgow, Scotland, 2001, p 17.

By the invention, not only a simple and inexpensive multi-channel RF transmit functionality can be provided, but also an easy upgrade of installed one-channel MRI systems can be realized to incorporate the multi-channel RF transmit functionality.

As mentioned above, the described multi-channel RF transmitter arrangements also address the problems of independent transmit sensitivities, which are required for high reduction factors. The increase of the number of RF transmit channels, for example by doubling the second RF transmitters 13, 14, 16 in the circumferential direction of the body coil 11, does not consequently lead to higher possible reduction factors, as the similarity of the sensitivities increases with reducing distance between adjacent RF transmitters. The sensitivities of the body coil 11 and of the second RF transmitters 12 to 16 are in principle dissimilar because of the global and local RF excitation.

Finally, the quadrature body coil 11 and its sensitivities for RF transmitting and receiving can be used in several methods and procedures, for example as a reference for the transmit or receive parallel imaging methods, like e.g. the above mentioned SENSE methods. In known multi-channel RF transmit systems, this reference has to be generated artificially, which requires additional effort and measurement time or might lead to errors. According to the invention, the quadrature body coil reference is still available for all methods and procedures.

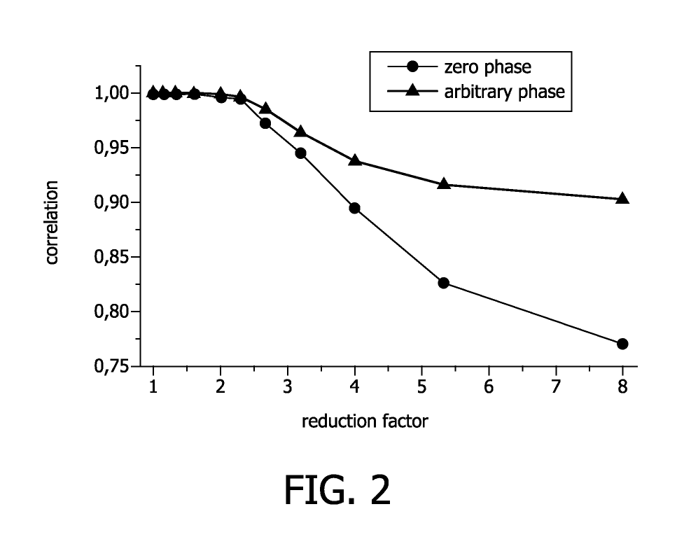

FIG. 2 shows correlation between desired and obtained magnitude for excitation patterns with zero phase (bullets, standard method) and optimized, arbitrary phase (triangles, this invention). Eight transmit sensitivities simulated for an 8-channel whole body system, a circular excitation pattern, and a spiral k-space trajectory was used. Different polynomial phase distributions up to third order have been tested. For R>2, an arbitrary (polynomial) phase distribution yields significantly better results than a zero phase. For R=8, the correlation difference between the two cases is almost 15%.

While the invention has been illustrated and described in detail in the drawings and foregoing description, such illustration and description are to be considered illustrative or exemplary and not restrictive, and the invention is not limited to the disclosed embodiments. Variations to embodiments of the invention described in the foregoing are possible without departing from the scope of the invention as defined by the accompanying claims.

Variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A multi-channel RF transmitter arrangement in the form of, or comprising, a plurality of RF transmitters, comprising at least one first RF transmitter for generating a global or extensive RF field, and at least one second RF transmitter positioned within the global or extensive RF field for generating each a local RF field within the global or extensive RF field.

2. A multi-channel RF transmitter arrangement according to claim 1, wherein the first RF transmitter is provided in the form of a cylindrical coil or a body coil, or two planar antenna structures which are positioned at least substantially parallel to each other and at the axial ends of a cylindrical volume, wherein the global or extensive RF field extends within the volume enclosed by the cylindrical coil or body coil, or within the volume between the two planar antenna structures, respectively.

3. A multi-channel RF transmitter arrangement according to claim 1, wherein two first RF transmitters are provided in the form of two quadrature modes of a quadrature body coil.

4. A multi-channel RF transmitter arrangement according to claim 1, wherein at least one second RF transmitter is provided in the form of RF antenna elements, coils, coil elements, loops, TEM element coils, and/or segmented antenna elements, or RF resonator elements.

5. A multi-channel RF transmitter arrangement according to claim 1, wherein a plurality of second RF transmitters is provided, which are positioned within a plane or surface of the first RF transmitter.

6. A multi-channel RF transmitter arrangement according to claim 1, wherein at least one second RF transmitter is provided in the form of an RF transmit surface coil or of a movable coil or a pad or a head coil.

7. A multi-channel RF transmit system comprising a plurality of RF waveform generators and at least one high power RF amplifier and a plurality of lower or midrange power RF amplifiers for generating RF transmit signals for feeding a multi-channel RF transmitter arrangement according to claim 1, wherein the at least one high power RF amplifier is provided for feeding the at least one first RF transmitter and the lower or midrange power RF amplifiers are provided for feeding each one of the second RF transmitters.

8. A multi-channel RF transmitter arrangement as claimed in claim 1, arranged to activate individual RF transmitters to produce the respective local RF fields which in superposition form a compound RF field that satisfies a predetermined spatial magnitude pattern.

9. A multi-channel RF transmitter arrangement as claimed in claim 8, wherein the local RF fields are set up to superpose the compound RF field under the constraint of a pre-determined maximum gradient of the spatial phase variation of the pre-determined spatial magnitude pattern.

10. A magnetic resonance imaging system comprising a multi-channel RF transmitter arrangement according to claim 1 and a multi-channel RF transmit system.

11. A method for generating an RF field by means of a multi-channel RF transmitter arrangement according to claim 1, in which the generation of the global and local RF fields is conducted in parallel or at least substantially at the same time.

12. A computer program comprising a computer program code adapted to perform a method or for use in a method according to claim 9 when said program is run on a programmable microcomputer.
